(19) United States
(12) Patent Application Publication
(10) Pub. No.: US 2023/0369687 A1
(43) Pub. Date: Nov. 16, 2023

(54) Apparatus For Manufacturing Pouch Of Secondary Battery And Pouch Of Secondary Battery Manufactured Thereby

(71) Applicant: LG Energy Solution, Ltd., Seoul (KR)

(72) Inventors: Chung Hee Lee, Daejeon (KR); Se Young Oh, Daejeon (KR); Geun Hee Kim, Daejeon (KR)

(73) Assignee: LG Energy Solution, Ltd., Seoul (KR)

(21) Appl. No.: 18/028,132

(22) PCT Filed: Nov. 3, 2021
(86) PCT No.: PCT/KR2021/015813

§ 371 Date: Mar. 23, 2023

(30) Foreign Application Priority Data
Nov. 4, 2020 (KR) 10-2020-0146226

(51) Int. Cl. H01M 50/105; H01M 10/04

(52) U.S. Cl. CPC H01M 50/105; H01M 10/0404

(57) ABSTRACT

An apparatus for manufacturing a pouch of a secondary battery includes: a lower die, a punch, and a stripper. The punch is inserted into the accommodation groove of the lower die to mold the cup part of the pouch. The stripper presses a peripheral part of the pouch. The bridge part is configured to connect the left accommodation groove and the right accommodation groove to each other. The bridge part includes a pillar portion and a top portion formed as a curve on an upper end of the pillar portion. The height of the top portion is less than ½ of a width of the pillar portion. A pouch of a secondary battery manufactured by the apparatus is also provided.

### CROSS-REFERENCE TO RELATED APPLICATION

The present application claims the benefit of the priority of Korean Patent Application No. 10-2020-0146226, filed on Nov. 4, 2020, which is hereby incorporated by reference in its entirety.

### TECHNICAL FIELD

The present invention relates to an apparatus for manufacturing a pouch of a secondary battery and a pouch of a secondary battery, which is manufactured by the apparatus, and more particularly, to an apparatus for manufacturing a pouch of a secondary battery, in which, when the pouch having two cup parts is molded, the pouch is molded by relieving a pressure applied to a pouch bridge that is a narrow connection part between the two cup parts to improve quality of a finally molded pouch product, and a pouch of a secondary battery manufactured by the method.

### BACKGROUND ART

In recent years, the price of energy sources increases due to the depletion of fossil fuels, the interest in environmental pollution is amplified, and the demand for eco-friendly alternative energy sources is becoming an indispensable factor for future life. Accordingly, studies on various power generation technologies such as solar power, wind power, and tidal power are continuing, and power storage devices such as batteries for more efficiently using the generated electrical energy are also of great interest.

Furthermore, as technology development and demand for electronic mobile devices and electric vehicles using batteries increase, the demands for batteries as energy sources are rapidly increasing. Thus, many studies on batteries which are capable of meeting various demands have been conducted.

In particular, in terms of materials, there is a high demand for lithium secondary batteries such as lithium ion batteries and lithium ion polymer batteries having advantages such as high energy density, discharge voltage, and output stability.

The secondary batteries are classified into cylindrical batteries and prismatic batteries, in which an electrode assembly is embedded in a cylindrical or prismatic metal can, and pouch-type batteries, in which an electrode assembly is embedded in a pouch-type case made of an aluminum laminate sheet according to shapes of battery cases.

FIG. 1 illustrates an example of a pouch-type secondary battery. In detail, FIG. 1 is an exploded perspective view of a pouch of a secondary battery and an electrode assembly, which is embedded in the pouch.

A pouch-type secondary battery 1 includes an electrode assembly 20, in which electrodes and separators are alternately stacked, and a pouch 10, into which the electrode assembly is inserted. In addition, the pouch includes cup parts 11 and 12 of the pouch, each of which has a recessed shape so that the electrode assembly is directly accommodated. The cup parts of the pouch are provided with the left cup part 11 and the right cup part 12 to surround the electrode assembly at both sides thereof. A peripheral part 14 of the pouch is formed around the periphery of each of the cup parts of the pouch to seal the pouch from the outside.

The pouch illustrated in FIG. 1 shows a pouch 10, in which two cup parts are formed on a flat pouch surface. The pouch having the above-described shape may be manufactured through an apparatus for manufacturing the pouch of the secondary battery, which is formed as a molding die.

In the secondary battery, as a width of the pouch bridge portion, which is a connection part of the left cup part and the right cup part, is reduced, a space loss in a battery pack may be reduced. Therefore, the need to reduce the width of the pouch bridge portion is high. However, as the width of the pouch bridge portion decreases, the pressure applied to the pouch bridge molding part increases, and thus, there is a problem in that probability of occurrence of cracks on a pouch surface of the pouch bridge increases. Therefore, there is a problem in that the cracks have to be prevented from occurring while reducing the width of the pouch bridge.

### DISCLOSURE OF THE INVENTION

### Technical Problem

The present invention has been devised to solve the above problems, and an object of the present invention is to provide an apparatus for manufacturing a pouch of a secondary battery, in which, when the pouch having two cup parts is molded, the pouch is molded by relieving a pressure applied to a pouch bridge that is a narrow connection part between the two cup parts to improve quality of a finally molded pouch product. In addition, an object of the present invention is to provide a pouch of a secondary battery manufactured by the apparatus for manufacturing the pouch of the secondary battery.

### Technical Solution

An apparatus for manufacturing a pouch of a secondary battery includes: a lower die in which an accommodation groove for molding a cup part of the pouch in a base surface, on which the pouch is disposed; a punch inserted into the accommodation groove of the lower die to mold the cup part of the pouch; and a stripper provided to press a peripheral part of the pouch, which is disposed around a portion to be molded as the cup part of the pouch by the punch, wherein two accommodation grooves provided with a left accommodation groove and a right accommodation groove are formed in the lower die, a bridge part configured to connect the two accommodation grooves to each other is formed between the left accommodation groove and the right accommodation groove, the bridge part includes a pillar portion of which lateral sides are formed as two straight lines and a top portion formed as a curve on an upper end of the pillar portion, based on a cross-sectional view, and a height (h) of the top portion, which is measured at an upper end of the pillar portion, is less than ½ of a width (W) of the pillar portion.

The height (h) of the top portion, which is measured at the upper end of the pillar portion, may be greater than 1/10 of the width (W) of the pillar portion.

The width (W) of the pillar portion may range of 0.9 mm to 1.1 mm, and the height (h) of the top portion may range of 0.09 mm to 0.55 mm.

The width (W) of the pillar portion may range of 0.9 mm to 1.1 mm, and the height (h) of the top portion may range of 0.2 mm to 0.4 mm.

The curve of the top portion may have a shape forming a portion of an oval.

A top point that is the highest point of the top portion may be disposed on a center line (L) that is a virtual straight line crossing a center of the pillar portion.

The top portion may have a horizontally symmetrical shape with respect to the center line (L).

A cross-sectional shape of the top portion may be uniform in a longitudinal direction (Y) of the bridge part.

A pouch of a secondary battery includes: a cup part of the pouch, which is provided with two left and right cup parts; and a peripheral part of the pouch, which extends outward from an upper end of each of the left cup part and the right cup part; and a pouch bridge configured to connect the left cup part to the right cup part, wherein the bridge part includes a pouch pillar of which lateral sides are formed as two straight lines and a pouch top formed as a curve on an upper end of the pouch pillar, based on a cross-sectional view, and a height (h) of the pouch top, which is measured at an upper end of the pouch pillar, is less than ½ of a width (W) of the pouch pillar.

The height (h) of the pouch top, which is measured at the upper end of the pouch pillar, may be greater than 1/10 of the width (W) of the pouch pillar.

### Advantageous Effects

The apparatus for manufacturing the pouch of the secondary battery may include the lower die in which the accommodation groove for molding the cup part of the pouch in the base surface, on which the pouch is disposed, the punch inserted into the accommodation groove of the lower die to mold the cup part of the pouch, and the stripper provided to press the peripheral part of the pouch, which is disposed around the portion to be molded as the cup part of the pouch by the punch, wherein the two accommodation grooves provided with the left accommodation groove and the right accommodation groove are formed in the lower die, the bridge part configured to connect the two accommodation grooves to each other is formed between the left accommodation groove and the right accommodation groove, the bridge part includes the pillar portion of which the lateral sides are formed as the two straight lines and the top portion formed as the curve on the upper end of the pillar portion, based on the cross-sectional view, and the height (h) of the top portion, which is measured at the upper end of the pillar portion, is less than ½ of the width (W) of the pillar portion. Therefore, when the pouch having two cup parts is molded, the pouch is molded by relieving the pressure applied to the pouch bridge that is the narrow connection part between the two cup parts to improve the quality of the finally molded pouch product. In addition, the pouch of the secondary battery, which has excellent quality, may be manufactured by the apparatus.

### BRIEF DESCRIPTION OF THE DRAWINGS

FIG. 1 is an exploded perspective view of a pouch of a secondary battery and an electrode assembly, which is embedded in the pouch.

FIG. 2 is a perspective view of an apparatus for manufacturing a pouch of a secondary battery according to Embodiment 1 of the present invention.

FIG. 3(a) is a plan view of a lower die in the apparatus for manufacturing the pouch of the secondary battery according to Embodiment 1 of the present invention when viewed from the top.

FIG. 3(b) is a cross-sectional view taken along line I-I′ of FIG. 3(a).

FIG. 4 is an enlarged view illustrating a portion S of FIG. 3(b).

FIG. 5 is a partial cross-sectional view illustrating a pouch bridge portion of the pouch of the secondary battery in the apparatus for manufacturing the pouch of the secondary battery according to Embodiment 1 of the present invention.

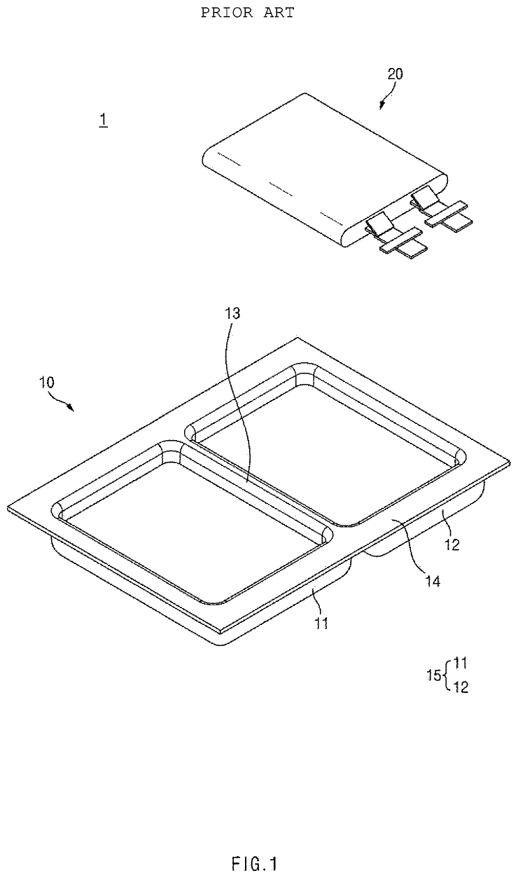

### MODE FOR CARRYING OUT THE INVENTION

Hereinafter, preferred embodiments of the present invention will be described in detail with reference to the accompanying drawings so that those of ordinary skill in the art can easily carry out the present invention. However, the present invention may be implemented in several different forms and is not limited or restricted by the following examples.

In order to clearly explain the present invention, detailed descriptions of portions that are irrelevant to the description or related known technologies that may unnecessarily obscure the gist of the present invention have been omitted, and in the present specification, reference symbols are added to components in each drawing. In this case, the same or similar reference numerals are assigned to the same or similar elements throughout the specification.

Also, terms or words used in this specification and claims should not be restrictively interpreted as ordinary meanings or dictionary-based meanings, but should be interpreted as meanings and concepts conforming to the scope of the present invention on the basis of the principle that an inventor can properly define the concept of a term to describe and explain his or her invention in the best ways.

### Embodiment 1

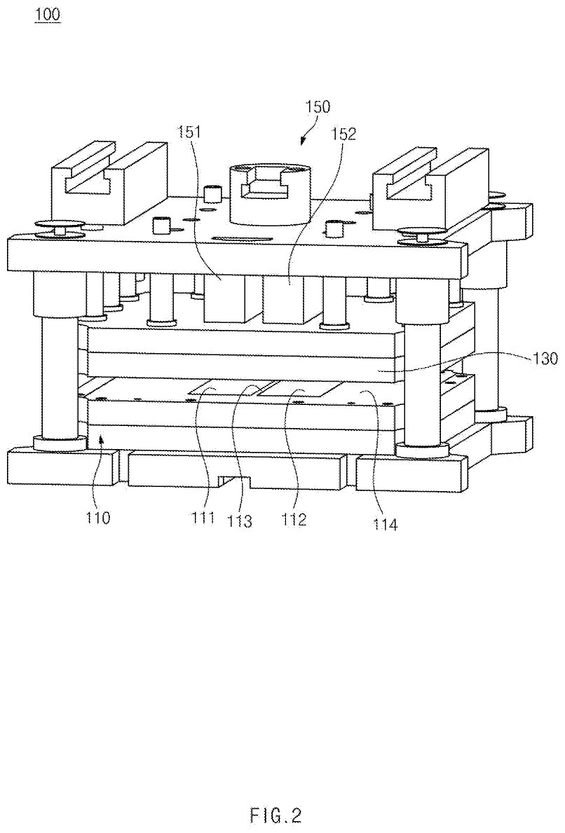

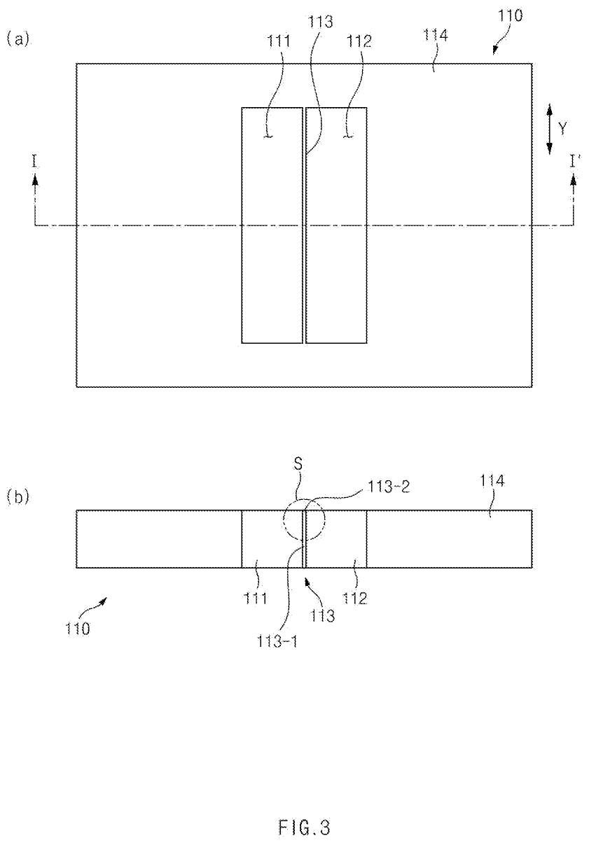

FIG. 2 is a perspective view of an apparatus for manufacturing a pouch of a secondary battery according to Embodiment 1 of the present invention. FIG. 3(a) is a plan view of a lower die in the apparatus for manufacturing the pouch of the secondary battery according to Embodiment 1 of the present invention when viewed from the top.

Referring to FIGS. 2 to 3(a), an apparatus 100 for manufacturing a pouch of a secondary battery according to Embodiment 1 of the present invention includes a lower die 110, a punch 150, and a stripper 130.

The lower die 110 may be disposed below to mold the pouch and may have a base surface 114, on which the pouch is disposed, on an upper portion thereof. In addition, the lower die 110 has accommodation grooves 111 and 112 for molding cup parts 11 and 12 of the pouch on the base surface 114 on which the pouch is disposed. The punch 150 may be configured to mold the cup parts 11 and 12 of the pouch while being inserted into the accommodation grooves of the lower die 110. The stripper 130 may be configured to press a peripheral part 14 of the pouch, which is disposed in the periphery of a portion to be molded into the cup part of the pouch, from an upper side by the punch 150. For this, the stripper 130 may be disposed above a lower die 110 to face the lower die 110.

The stripper 130 and the lower die 110 may press and grip upper and lower portion of the peripheral part 14 of the pouch, respectively, and in the state in which the peripheral part 14 of the pouch is gripped by the stripper 130 and the lower die 110, the punch 150 may be inserted into the accommodation grooves to mold the cup part of the pouch.

Two accommodation grooves, i.e., a left accommodation groove 111 and a right accommodation groove 112 may be formed in the lower die 110. The left cup part 11 may be formed through the left accommodation groove 111, and the right cup part 12 may be formed through the right accommodation groove 112. A bridge part 113 connecting the two accommodation grooves to each other may be formed between the left accommodation groove 111 and the right accommodation groove 112.

Two accommodation grooves, i.e., a left accommodation groove 111 and a right accommodation groove 112 may be formed in the lower die 110, and thus, the punch 150 may include a left punch 151 inserted into the left accommodation groove 111 and a right punch 152 inserted into the right accommodation groove 112.

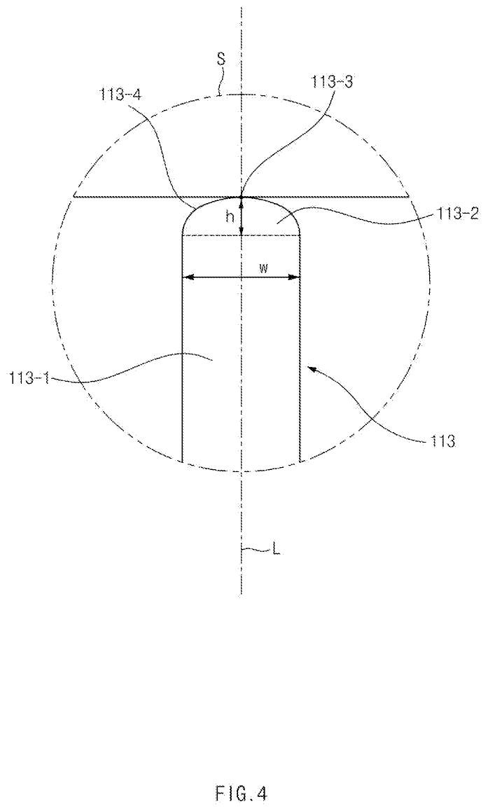

FIG. 3(b) is a cross-sectional view taken along line I-I′ of FIG. 3(a). FIG. 4 is an enlarged view illustrating a portion S of FIG. 3(b).

Referring to FIGS. 3(a), 3(b), and 4, in the apparatus for manufacturing the pouch of the secondary battery according to Embodiment 1 of the present invention, the bridge part may include a pillar portion of which lateral sides are formed as two straight lines and a top portion formed as a curve on an upper end of the pillar portion. Here, a height h of the top portion measured from the upper end of the pillar portion may have a value less than ½ of a width W of the pillar portion.

When the height h of the top portion has a value less than ½ of the width W of the pillar portion, the upper end of the bridge part is formed gently enough. Thus, when the pouch having the two cup parts are molded, the pouch may be molded by relieving a pressure applied to the pouch bridge that is the connection part, in which a width between the two cup parts is narrowed. Thus, quality of a finally molded pouch product may be improved.

When the height h of the top portion is greater than ½ of the width W of the pillar portion, since the pressure applied to the pouch bridge increases, there is a problem in that cracks or whitening may occur in the surface of the pouch at the pouch bridge portion.

In addition, in the apparatus for manufacturing the pouch of the secondary battery according to Embodiment 1 of the present invention, the height h of the top portion, which is measured at the upper end of the pillar portion may be greater than 1/10 of the width W of the pillar portion.

When the height h of the top portion is less than 1/10 of the width W of the pillar portion, since the top portion has a shape to be close to a plane, a problem in which both ends of the pouch bridge are excessively bent may occur. In addition, in the manufacturing of the lower die so that the top portion has a shape close to the plane, there is a problem in that it is difficult to manufacture the lower die itself.

In the apparatus for manufacturing the pouch of the secondary battery according to Embodiment 1 of the present invention, specifically, the width W of the pillar portion may be 0.9 mm to 1.1 mm, and the height h of the top portion may be 0.09 mm to 0.55 mm.

That is, since a minimum value of the height h of the top portion corresponds to 1/10 of the width W of the pillar portion, the minimum value may be 0.09 mm that corresponds to 1/10 of 0.9 mm. Since the minimum value of the height h of the top portion corresponds to ½ of the width W of the pillar portion, the minimum value may be 0.55 mm that corresponds to ½ value of 1.1 mm.

More preferably, when the width W of the pillar portion is 0.9 mm to 1.1 mm, the height h of the top portion may be 0.2 mm to 0.4 mm. When the width W of the pillar portion is 0.9 mm to 1.1 mm, if the height h of the top portion has a value of 0.2 mm˜0.4 mm, an excellent pouch product that is capable of maximizing ease of manufacturing the lower die and efficiency of the space inside the battery without the cracks.

Referring to FIG. 4, the curved space of the top portion may be a space forming a portion of an oval. Also, a top point, which is the highest point of the top portion, may be disposed on a center line L, which is a virtual straight line crossing a center of the pillar portion. Here, the top portion may have a horizontally symmetrical shape with respect to the center line L.

When the top portion is formed in this shape, the most stable pouch molding may be possible, and the pouch having the excellent quality may be realized without an occurrence of fine wrinkles on the surface of the pouch.

The cross-sectional shape of the top portion illustrated in FIG. 4 may be uniform in a longitudinal direction Y of the bridge part (see FIG. 3(a)). Thus, a balanced secondary battery may be manufactured.

### Embodiment 2

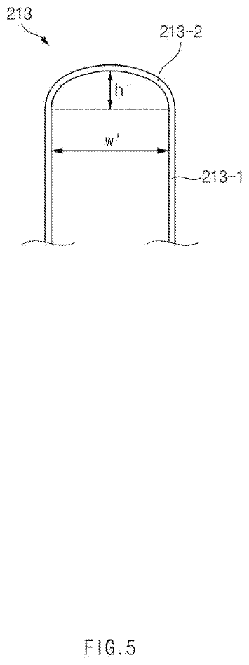

FIG. 5 is a partial cross-sectional view illustrating a pouch bridge portion of the pouch of the secondary battery in the apparatus for manufacturing the pouch of the secondary battery according to Embodiment 1 of the present invention.

Embodiment 2 of the present invention relates to a pouch of a secondary battery, which is manufactured by the apparatus for manufacturing the pouch of the secondary battery according to Embodiment 1 of the present invention.

The contents that are duplicated with Embodiment 1 will be omitted as much as possible, and Embodiment 2 will be described with a focus on the differences. That is, it is obvious that the contents that are not described in Embodiment 2 may be regarded as the contents of Embodiment 1 if necessary.

The pouch of the secondary battery according to Embodiment 2 of the present invention includes a cup part of the pouch, which is provided with two left and right cup parts, a peripheral part of the pouch, which extends outward from an upper end of each of the left cup part and the right cup part, and a pouch bridge connecting the left cup part to the right cup part.

Referring to FIG. 5, the pouch bridge may include a pouch pillar of which lateral sides are formed as two straight lines, and a pouch top formed in a curve at an upper end of the pouch pillar, based on a cross-sectional view.

In addition, a height h′ of the pouch top, which is measured from the upper end of the pouch pillar, may have a value less than ½ of a width W′ of the pouch pillar.

This may be in the form of the pouch bridge formed by the lower die bridge part of the apparatus for manufacturing the pouch of the secondary battery according to Embodiment 1 of the present invention, which is illustrated in FIG. 4.

In the pouch of the secondary battery according to Embodiment 2 of the present invention, since the height h of the top portion is formed to be less than ½ of the width W of the pillar portion, cracks or whitening may not occur on the pouch surface of the pouch bridge portion to realize the excellent quality.

Also, in the pouch of the secondary battery according to Embodiment 2 of the present invention, the height h′ of the pouch top, which is measured from the upper end of the pouch pillar, may be a value greater than 1/10 of the width W′ of the pouch pillar.

In this case, a problem in which both ends of the pouch bridge are excessively bent may not occur to manufacture the pouch of the secondary battery, which has the excellent quality.

While the embodiments of the present invention have been described with reference to the specific embodiments, it will be apparent to those skilled in the art that various changes and modifications may be made without departing from the spirit and scope of the invention as defined in the following claims.

### DESCRIPTION OF THE SYMBOLS

1: Secondary battery
10: Pouch
11: Left cup part
12: Right cup part
13: Pouch bridge
14: Peripheral part of pouch
15: Cup part of pouch
20: Electrode assembly
100: Apparatus for manufacturing pouch of secondary battery
110: Lower die
111: Left accommodation groove
112: Right accommodation groove
113: Bridge part
113-1: Pillar portion
113-2: Top portion
113-3: Top point
113-4: Curve of top portion
114: Base surface
130: Stripper
150: Punch
151: Left punch
152: Right punch
213: Pouch bridge
213-1: Pouch pillar
213-2: Pouch top

1. An apparatus for manufacturing a pouch of a secondary battery, the apparatus comprising:
a lower die having a base surface and a plurality of accommodation grooves for molding a cup part of the pouch when the pouch is disposed on the base surface;
a punch configured to be inserted into the accommodation grooves of the lower die to mold the cup part of the pouch; and
a stripper provided to press a peripheral part of the pouch, the peripheral part being disposed around a portion of the pouch to be molded as the cup part by the punch,
wherein the plurality of accommodation grooves includes a left accommodation groove and a right accommodation groove,
a bridge part formed between the left accommodation groove and the right accommodation groove, the bridge part configured to connect the left and right accommodation grooves to each other,
the bridge part comprises a pillar portion of which lateral sides are formed as two straight lines and a top portion formed as a curve on an upper end of the pillar portion, and
a height of the top portion is less than ½ of a width of the pillar portion.

2. The apparatus of claim 1, wherein the height of the top portion is greater than 1/10 of the width of the pillar portion.

3. The apparatus of claim 2, wherein the width of the pillar portion ranges from 0.9 mm to 1.1 mm, and
the height of the top portion ranges from 0.09 mm to 0.55 mm.

4. The apparatus of claim 2, wherein the width of the pillar portion ranges from 0.9 mm to 1.1 mm, and
the height of the top portion ranges from 0.2 mm to 0.4 mm.

5. The apparatus of claim 1, wherein the curve of the top portion has a shape forming a portion of an oval.

6. The apparatus of claim 1, wherein a top point that is the highest point of the top portion is disposed on a central longitudinal axis of the pillar portion.

7. The apparatus of claim 6, wherein the top portion has a horizontally symmetrical shape with respect to the central longitudinal axis.

8. The apparatus of claim 1, wherein a cross-sectional shape of the top portion is uniform in a longitudinal direction extending along the central longitudinal axis.

9. A pouch of a secondary battery, the pouch comprising:
a cup part of the pouch, which is provided with a left cup part and a right cup parts;
a peripheral part of the pouch, which extends outward from an upper end of each of the left cup part and the right cup part; and
a pouch bridge configured to connect the left cup part to the right cup part,
wherein the pouch bridge comprises a pouch pillar of which lateral sides are formed as two straight lines and a pouch top formed as a curve on an upper end of the pouch pillar, and
a height of the pouch top is less than ½ of a width of the pouch pillar.

10. The pouch of claim 9, wherein the height of the pouch top is greater than 1/10 of the width of the pouch pillar.
